(19) United States
(12) Patent Application Publication
(10) Pub. No.: US 2024/0374478 A1
(43) Pub. Date: Nov. 14, 2024

(54) DISSOLUTION ADAPTER, METHOD OF MANUFACTURE THEREOF AND METHOD OF USE THEREOF

(71) Applicant: University of Connecticut, Farmington, CT (US)

(72) Inventors: Diane J. Burgess, Mansfield, CT (US); Nileshkumar Malavia, Willimantic, CT (US); Quanying Bao, Willimantic, CT (US)

(21) Appl. No.: 18/658,102

(22) Filed: May 8, 2024

Related U.S. Application Data
(60) Provisional application No. 63/464,677, filed on May 8, 2023.

(51) Int. Cl. A61J 1/20

(52) U.S. Cl. CPC A61J 1/2089; A61J 1/2037; A61J 1/2048

(57) ABSTRACT

Disclosed herein is an adapter for use in facilitating dissolution, the adapter comprising a container body and a cavity that is operative to contain a suspension disposed in the container body; where the cavity comprises a conical section that protrudes into the container body; or where the cavity comprises a partial ellipsoidal shape that protrudes into the container body.

### CROSS-REFERENCE TO RELATED APPLICATIONS

This disclosure claims priority to U.S. Provisional Application No. 63/464,677, filed on May 8, 2023, the entire contents of which are incorporated herein in their entirety.

### GOVERNMENT SUPPORT

The invention was made with government support from the Food and Drug Administration (FDA) grants HHSF223201710135C and 75F40121C00133. The government has certain rights in the invention.

### BACKGROUND

This disclosure relates to a dissolution adapter, methods of manufacture thereof and methods of use thereof. In particular, this disclosure relates to a dissolution adapter for in vitro release testing of long-acting injectable suspensions, methods of manufacture thereof and methods of use thereof.

Long-acting injectable suspensions are medications that are administered via injection and designed to release the active ingredient gradually over an extended period. These formulations are often used to provide sustained therapeutic effects, reducing the frequency of administration compared to shorter-acting formulations. They can be particularly beneficial for conditions that need ongoing treatment and adherence to medication schedules.

Currently, there are about ten long-acting injectable suspension products that have been approved by the United States Food and Drug Administration (US FDA). To promote the continued development of these products in the pharmaceutical pipeline, it is desirable to develop a robust and reproductive in vitro release testing and in vivo predictive methods to make sure that the efficacy, safety, and the product quality characteristics of these products are met.

The FDA has recommended several testing methods for long-acting injectable suspensions to ensure their safety, efficacy, and quality. These testing methods help assess various aspects of the product, including its physical characteristics, chemical composition, stability, and performance. Some of the FDA-recommended testing methods for long-acting injectable suspensions include particle size analysis, viscosity measurements, chemical composition analysis, stability studies, drug release profile, microbiological testing, container body closure integrity, or a combination thereof. These testing methods, along with others specific to the formulation and therapeutic requirements, are integral parts of the regulatory assessment and approval process for long-acting injectable suspensions. They help confirm product quality, safety, and efficacy before they are made available to patients.

The FDA has recommended testing methods for these products that includes United States Pharmacopeia (USP) paddle (apparatus type II) (which is primarily used for testing the dissolution of solid dosage forms, but can also be adapted for suspensions and other liquid formulations or flow through cell apparatus) or (apparatus type IV) (which is specifically designed for testing the dissolution of semi-solid and liquid formulations), including suspensions for a time range of 45 minutes to 2880 minutes. Although these methods have been recommended by US FDA for some of the long-acting injectable products, release testing methods with a longer duration are desirable for the purpose of in vitro-in vivo correlations (IVIVCs).

Semi-solid adapters such as those used for testing of ointments have been used by few researchers to improve the release testing in terms of reproducibility and discrimination. Although these adapters show good reproducibility and discrimination, the testing uses sophisticated sample loading techniques. Samples may smear during sample loading, leading to high standard deviations in the resulting data.

### SUMMARY

Disclosed herein is an adapter for use in facilitating dissolution, the adapter comprising: a container body and a cavity that is operative to contain a suspension disposed in the container body; where the cavity comprises a conical section that protrudes into the container body; or where the cavity comprises a partial ellipsoidal shape that protrudes into the container body.

Disclosed herein too is an apparatus for facilitating dissolution, the apparatus comprising a reservoir comprising a dissolution media; where the dissolution media is operative to solvate a suspension that is therapeutically effective in a living being; and a cell located downstream of the reservoir and in contact with it; where the cell is operative to contain an adapter that carries the suspension; where the adapter comprises a container body; and a cavity disposed in the container body; where the cavity comprises a conical section that protrudes into the container body; or where the cavity comprises a partial ellipsoidal shape that protrudes into the container body.

Disclosed herein is an apparatus comprising a dissolution vessel that contains a rotating paddle shaft to which is affixed a paddle; where the dissolution vessel comprises a medium that is operative to solvate a suspension contained in an adapter; and an adapter disposed in the medium in the dissolution vessel; wherein the adapter comprises a die disposed in a sample cavity; where the die comprises a lid that contacts the upper portion of the sample cavity; and where the sample cavity comprises a container body having a downwardly protruding partial ellipsoid shape in which the suspension is disposed.

### BRIEF DESCRIPTION OF THE FIGURES

FIG. 1 is a depiction of USP apparatus type IV into which the adapters disclosed herein may be used;

FIG. 2 is a depiction of an exemplary cell in which adapter is disposed;

FIGS. 3(A)-3(E) depict exemplary embodiments of the preferred adapter for USP apparatus type IV;

FIGS. 4(A), 4(B) and 4(C) depict other exemplary embodiments of the adapter for USP apparatus type IV;

FIG. 5 depicts an exemplary embodiment of a USP apparatus type II in which the adapter disclosed herein is disposed;

FIGS. 6(A), 6(B) and 6(C) are depictions of an exemplary die for the adapter preferably used in USP apparatus type II;

FIGS. 7(A), 7(B) and 7(C) are depictions of an exemplary sample cavity for the adapter preferably used in USP apparatus type II;

FIGS. 7(D), 7(E) and 7(F) are depictions of an exemplary sample cavity for the adapter (with a square outer periphery) preferably used in USP apparatus type II;

FIG. 8(A) is a graph that shows particle size;

FIG. 8(B) is a graph that shows particle size distribution of Depo Provera 150® and the in-house Q1Q2 equivalents;

FIG. 9(A) shows the dispersion of suspension samples in USP apparatus type-II;

FIG. 9(B) is a graph that depicts in vitro release profile of formulations “FA” and “FC” using USP apparatus type-II;

FIG. 10(A) is a photograph of a semisolid adapter;

FIG. 10(B) depicts suspension spreading over the flat surface of semisolid adapter placed in flow through cells;

FIG. 10(C) is a photograph of in vitro drug release of LAI suspension using semisolid adapter in a USP apparatus type-IV flow through cell; and

FIG. 10(D) is a graph that shows in vitro release profile of formulation “FA” and the “RLD” using USP apparatus type-II;

FIG. 11(A) is a graph that shows in vitro release profiles for formulation “FA” performed twice using the adapter in USP apparatus type-IV;

FIG. 11(B) reflects in vitro release profile of Depo Provera 150® and its Q1Q2 equivalents using the adapter in USP apparatus type-IV;

FIG. 12(A) is a graph showing in vitro release profiles using different dose volumes of formulation “FA” in the partial ellipsoid shaped adapter; and

FIG. 12(B) is a graph showing in vitro release profile of Depo Provera 150® and the in-house Q1Q2 equivalents using the partial ellipsoid shaped adapter in USP apparatus type-IV.

### DETAILED DESCRIPTION

Disclosed herein are new adapters that may be used in USP apparatus type II and USP apparatus type IV for the dissolution of oral and injectable suspensions, respectively. The new adapters prevent the oral suspensions or long-acting injectable suspensions from undergoing being non-uniformly distributed during the process of dissolution in a dissolution media. The adapters disclosed herein when used in USP apparatus type II (which simulates the physiological conditions of the gastrointestinal tract where the drug will be absorbed (for oral suspensions)) or in USP apparatus type IV (which simulates the absorption of long-acting injectable suspensions or the dissolution rate of solid dosage forms) helps manufacturers optimize their formulations and ensure that patients receive the intended therapeutic benefits from the medications they take. The media in either the USP apparatus type II or the USP apparatus type IV is often a buffer solution/suspension with specified pH and composition.

IVIVC stands for In Vitro-In Vivo Correlation. It's a term used in pharmaceutical development to describe the relationship between the in vitro (laboratory) behavior of a drug formulation and it's in vivo (within a living organism) performance. Essentially, IVIVC assesses how well the results obtained in laboratory studies can predict the behavior and efficacy of a drug in living systems, such as humans.

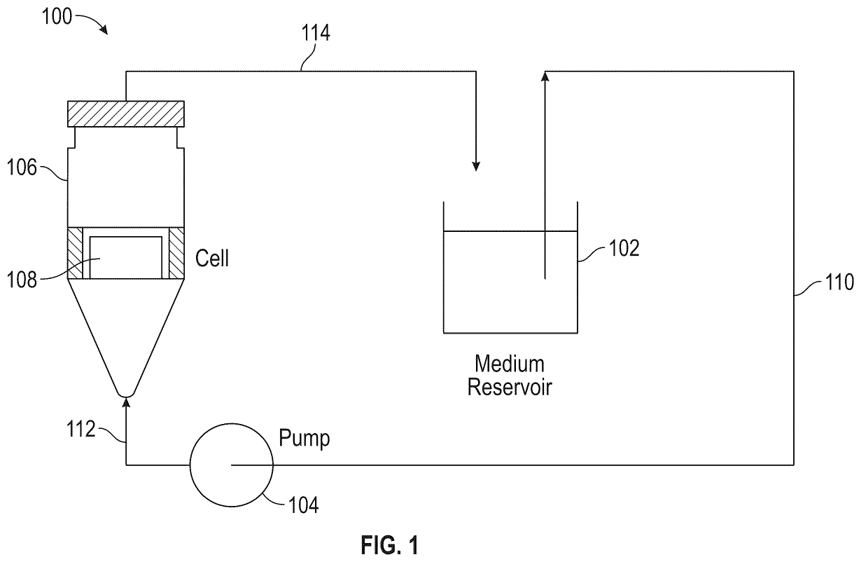

FIG. 1 is a depiction of USP apparatus type IV into which the adapters disclosed herein may be used. FIG. 1 is a depiction of an exemplary USP apparatus type IV (hereinafter apparatus 100) that is typically used for the dissolution of long-acting injectable suspensions. The apparatus 100 comprises a media reservoir 102 in fluid communication with a pump 104 that lies downstream of the reservoir 102. Conduit 110 facilitates fluid communication between the media reservoir 102 and the pump 104. Located downstream of pump 104 and upstream of reservoir 102 is cell 106 in which is disposed the adapter 108. Conduit 112 facilitates fluid communication between pump 104 and cell 106. The adapter 108 holds the injectable suspension that is diluted with a dissolution media (hereinafter media) contained in the reservoir 102. The apparatus 100 thus comprises a recycle loop wherein a media is discharged from the reservoir 102 via pump 104 into cell 106, where it contacts the suspension that is contained in the adapter 108. The suspension is one that is therapeutically effective or is believed to be therapeutically effective in the body of a living being. The dissolution media is operative to solvate the suspension upon coming in contact with it.

The media carries a portion of the suspension from adapter 108 back to reservoir 102. Conduit 114 facilitates fluid communication between cell 106 and reservoir 102. This process is repeated by continuously cycling the media contained in reservoir 102 through cell 106 until all of the suspension contained in adapter 108 is diluted by the media present in reservoir 102. The final product contained in the reservoir 102 (after all of the suspension is removed from the adapter 108) may be extracted for further analysis.

Examples of typical media used in the USP apparatus type IV include:
1. 1% w/v sodium dodecyl sulfate (SDS) in water
2. 1% w/v SDS in pH 7.4 PBS
3. Plain buffers at pH 1.0, 6.0, and 6.8
4. Fasted State Simulated Gastric Fluid (FaSSGF)—pH 1.6
5. Fasted State Simulated Intestinal Fluid (FaSSIF)—pH 6.5
6. Fed State Simulated Intestinal Fluid (FeSSIF)—pH 5.0
7. 0.1-1% sodium lauryl sulfate (SLS) at pH 7.4.
8. Acid (HCL—0.1 to 0.001 N)
9. Buffers acetate (pH 4.1-5.5, 0.05 M), phosphate (pH 5.8-8.00, 0.05 M).

Examples of suspensions that are examined in USP apparatus type IV include:
1. Sodium lauryl sulfate (SLS) or sodium dodecyl sulfate (SDS)—anionic surfactant
2. Cetyltrimethylammonium bromide (CTAB)—cationic surfactant
3. Polysorbate 80 (Tween 80)—nonionic surfactant
4. Brij—nonionic surfactant
5. Triton X®—nonionic surfactant
6. Bile salts (e.g. sodium taurocholate, sodium glycocholate)—anionic/zwitterionic
surfactants
7. Cyclodextrins
8. Lecithin
9. Solutol®
10. Cremophor®
11. Methylbenzethonium chloride
12. Tergitol®
13. Polyoxy 10 lauryl ether
14. Brij®
15. Polyoxyethylene sorbitan.

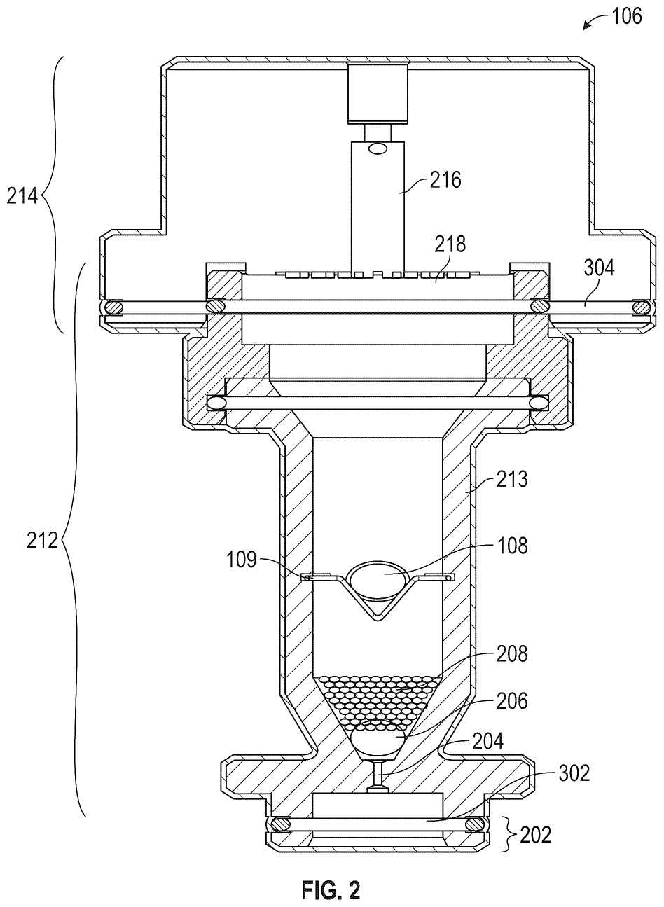

FIG. 2 is a depiction of an exemplary cell 106 in which adapter 108 is disposed. The cell 106 comprises a lower attachment fixture 202 and an upper attachment fixture 214 which contacts conduits 112 and 114 (See FIG. 1) respectively. As noted above the conduit 112 transports the media contained in the reservoir 102 to the cell 106 via pump 104 and conduit 114 transports a mixture of the media and the suspension (contained in the adapter 108) from cell 106 to reservoir 102. The lower attachment fixture 202 contacts an adapter holder 212 of cell 106 via a first seal or gasket 302 while the upper attachment fixture 214 contacts the adapter holder 212 of cell 106 via a second seal or gasket 304. The respective seals or gaskets prevent fluid (e.g., the media and/or the suspension) from being lost during the operation.

The adapter holder 212 lies between the lower attachment fixture 202 and an upper attachment fixture 214 and contains an inlet port 204 in fluid communication with the lower attachment fixture 202. The inlet port 204 is operative to permit the media from reservoir 102 to enter the adapter holder. Opposedly disposed to the inlet port 204 is an outlet port 218 where a mixture of the suspension and the media exit the adapter holder 212. The outlet port 218 is in fluid communication with a port 216 in the upper attachment fixture 214. Fluid exiting the outlet port 218 of the adapter holder 212 exits the cell 106 via port 216 and is transported to the reservoir 102 via conduit 114.

Disposed between the inlet port 204 and the outlet port 218 of the adapter holder 212 is a one-way valve 206, a porous frit 208 and the adapter 108. The one way valve is directly in communication with inlet port 204 and acts to prevent fluid (the mixture of the media and the suspension) from being inadvertently transported into the conduit 112. It is desirable for purposes of accurate analysis for the mixture of the media and the suspension to be transported only to the reservoir 102.

Located downstream of the one-way valve 206 is an optional porous frit 208. In an embodiment, the porous frit 208 serves as a filter to prevent any contamination from the media from diluting the suspension contained in the adapter 108. In another embodiment, the porous frit 208 may comprise packed beads. The porous frit or packed beads are preferably manufactured from a material that does not contaminate or react with either the media or the suspension. It is preferably manufactured from a non-reactive polymer or a metal oxide. Examples of non-reactive polymers include polyfluoroethylenes (e.g., polytetrafluoroethylene (PTFE), ethylene tetrafluoroethylene (ETFE), fluorinated ethylene propylene (FEP)), polyolefins (e.g., polyethylene, polypropylene, ethylene-propylene copolymers), polysiloxanes (e.g., polydimethylsiloxane, polydiphenylsiloxane), or a combination thereof. Examples of metal oxides that are used as the porous frit include zirconium oxide, titanium dioxide, silicon oxide, aluminum oxide, or a combination thereof. Other non-reactive materials can also be used in either bead form or in the form of a foam.

Disposed downstream of the one-way valve 206 and the optional porous frit 208 is the adapter 108. The adapter 108 is mounted on a fixed stage 109 situated in the walls 213 of the adapter holder 212. The fixed stage 109 supports the adapter 108 when it is placed in the adapter holder 212. The fixed stage 109 prevents the adapter 108 from contacting the porous frit 208 or the one-way valve 206. The fixed stage 109 may have any desired shape so that it can support the adapter 108 and prevent it from being dislodged when subjected to a flow field.

The adapter 108 may be introduced into the adapter holder 212 through outlet port 218, which is sized to accommodate the introduction and removal of the adapter 108. As will be discussed below there are spaces between inner surfaces of the walls 213 and an outer periphery of the adapter 108 to permit the flow of media around the adapter 108 such that it can contact the suspension and transport a portion of the suspension back to the reservoir 102 (see FIG. 1).

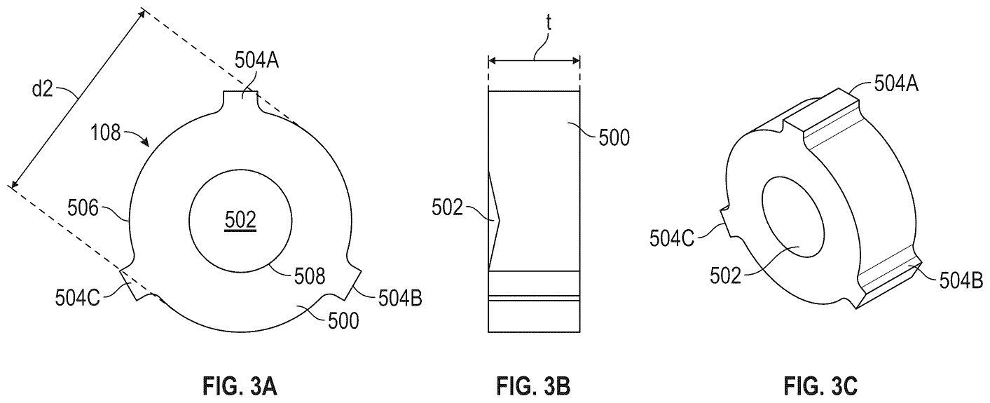

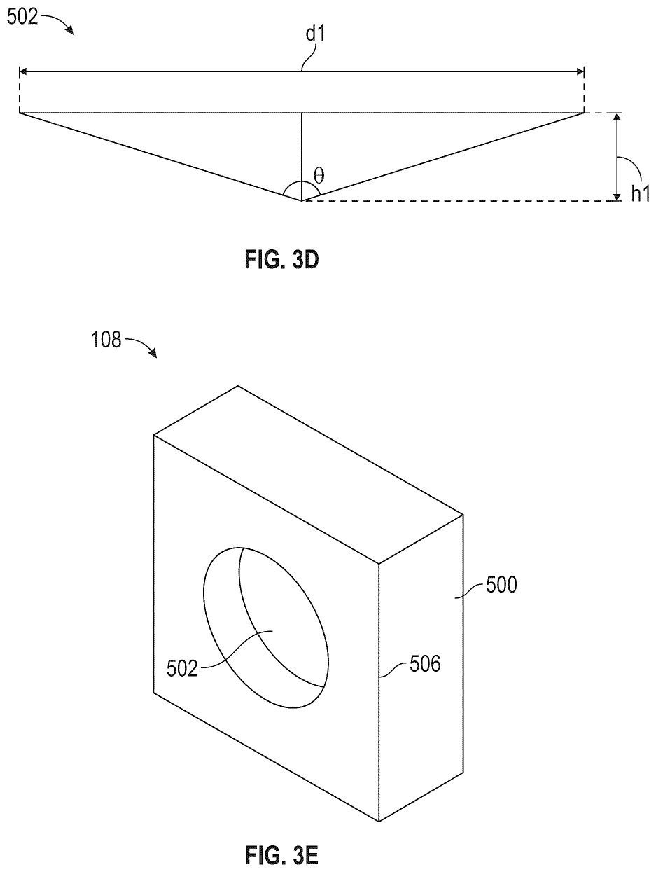

The adapter 108 for USP apparatus type IV will now be discussed in detail with respect to FIGS. 3(A)-3(E). FIGS. 3(A)-3(E) depict exemplary embodiments of the adapter 108. FIG. 3(A) is a top view, FIG. 3(B) is a side view, FIG. 3(C) is an isometric view of the adapter 108. FIG. 3(D) is geometric view of the sample cavity 502 that is contained in the adapter 108. FIG. 3(E) is an isometric view of an adapter 108 having a square outer periphery.

With reference now to the FIGS. 3(A), 3(B) and 3(C), the adapter 108 comprises a container body 500 with a sample cavity 502 and two or more protrusions 504A, 504B, 504C, . . . , and so on, extending from an outer periphery 506 of the container body 500. The periphery 506 of the container body may be circular, square, rectangular, ellipsoidal, triangular, polygonal (e.g., a pentagon, hexagon, any n-sided shape), or a combination thereof.

The sample cavity 502 is an upside-down cone and has an outer periphery that is circular. The sample cavity 502 may be concentric with the periphery 506 of the container body 500 or alternatively, it may be eccentric with the container body 500. The sample cavity 502 typically holds the suspension that is being diluted with the media in the USP apparatus type IV (see FIGS. 1 and 2). The cavity 502 protrudes into the body of the container body 500 and extends in the form of a conical section into the container body 500. FIG. 3(D) depicts only the geometry and dimensions of the cavity 502. From the FIG. 3(D), it may be seen that the upside-down conical cavity has an internal angle θ of about 130 to about 170 degrees, preferably about 145 to about 160 degrees. The height “h1” of the upside-down cone (also referred to herein as a conical section) is about 0.5 to about 3 millimeters, preferably about 1 to about 2 millimeters. The diameter “d1” of the base of the upside-down cone is about 7 to about 12 millimeters, preferably about 8 to about 10 millimeters. In an embodiment, the aspect ratio of the conical section (h1/d1) may be about 0.05 to about 0.5, preferably about 0.08 to about 0.45.

The container body 500 has a thickness “t” of about 5 to about 10 millimeters, preferably about 6 to about 9 millimeters. When the container body 500 has a circular periphery, the outer diameter “d2” of the periphery 506 is about 15 to about 26 millimeters, preferably about 18 to about 24 millimeters.

As noted above, there are two or more protrusions 504A, 504B, 504C, and so on, that extend outwards from the periphery. In an embodiment, the adapter 108 has three or more protrusions that extend outwards from the periphery. These protrusions rest on the fixed stage 109 (see FIG. 2) thus providing the adapter with stability when it is located in the flow field of the USP apparatus type IV (see FIGS. 1 and 2). By resting the protrusions on the fixed stage 109 (see FIG. 2), there is space (not shown) between the inner surface of wall 213 and the outer periphery 506 of the adapter 108 through which the media from the reservoir 102 can flow (see FIGS. 1 and 2) to dilute the suspension contained in cavity 502 and to transport some of the suspension to the reservoir 102 (see FIG. 1).

As noted above, the outer periphery 506 of the container body 500 may be square, rectangular, ellipsoidal, or a combination thereof amongst other shapes. FIG. 3(E) depicts an adapter 108 having a square outer periphery 506. All other numeric notations in the FIG. 3(E) are the same as those used in the FIGS. 3(A)-3(D).

The adapter with the conical cavity is advantageous when compared with conventional semi-solid adapters (adapters having flat bottoms) in terms of sample loading. This adapter can securely hold a suspension in place, and even the slight disturbance associated with assembling the flow-through cells does not cause spreading of the suspension.

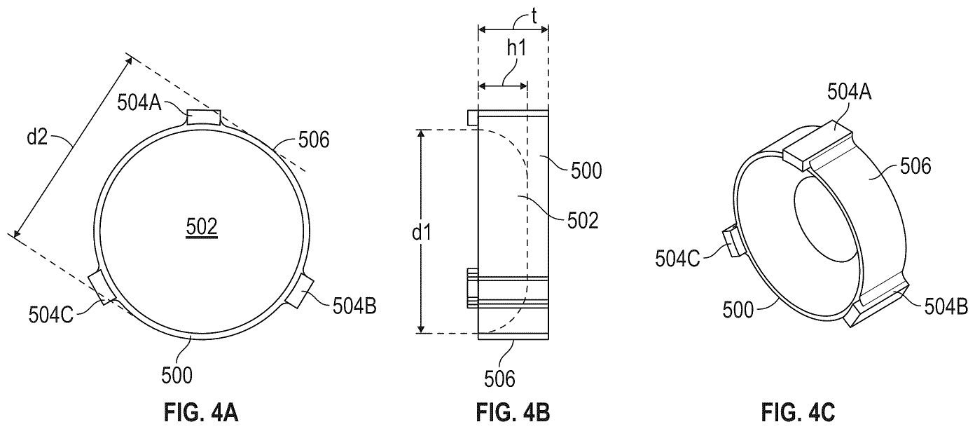

FIGS. 4(A), 4(B) and 4(C) depict other exemplary embodiments of adapter 108 (see FIG. 2) that comprises a container body 500 having a cavity 502 with a partial ellipsoidally shaped bottom surface. FIG. 4(A) is a top view, FIG. 4(B) is a side view and FIG. 4(C) is an isometric view of the adapter 108. The partial ellipsoidally shaped inner surface protrudes into the body of the container body 500. The height “h1” of the downwardly protruding partial ellipsoid is about 3 to about 6 millimeters, preferably about 3.5 to about 5 millimeters. The diameter “d1” of the base of the downwardly protruding partial ellipsoid is about 16 to about 22 millimeters, preferably about 17 to about 20 millimeters. In an embodiment, the aspect ratio of the downwardly protruding partial ellipsoid (h1/d1) may be about 0.13 to about 0.35, preferably about 0.18 to about 0.30.

The container body 500 the downwardly protruding partial ellipsoid disposed therein has a thickness “t” of about 6 to about 10 millimeters, preferably about 7 to about 9 millimeters. When container body 500 has a circular periphery, the outer diameter “d2” of the periphery 506 is about 20 to about 26 millimeters, preferably about 21 to about 25 millimeters.

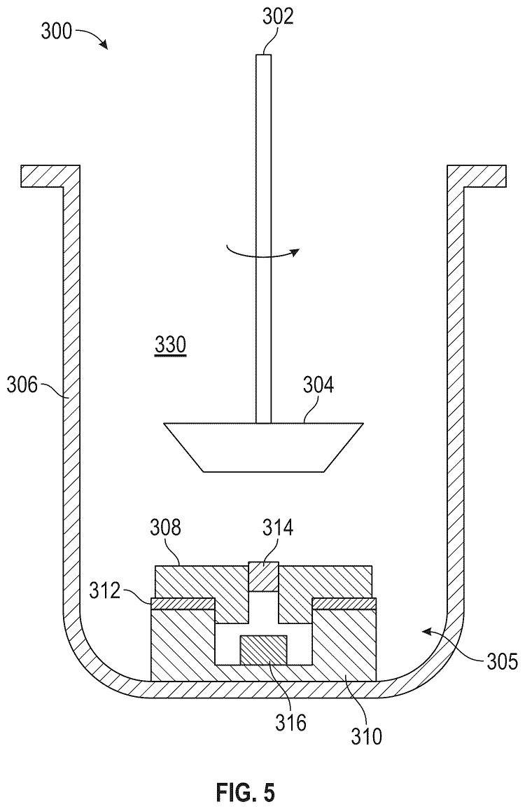

As noted above, this disclosure also provides details about adapters used in USP apparatus type II. FIG. 5 depicts an exemplary embodiment of a USP apparatus type II 300 that comprises a dissolution vessel 306 that contains a rotating paddle shaft 302 to which is affixed a paddle 304. The paddle 304 is in rotary communication with the rotating paddle shaft 302. The rotating paddle shaft 302 is in rotary communication with a motor (not shown). The dissolution vessel contains a medium into which the suspension may be dissolved.

Disposed at the bottom of the dissolution vessel 306 is an adapter 305 that is configured for use primarily with USP apparatus type II 300. The adapter 305 comprises a die 308 disposed in a sample cavity 310. An optional gasket 312 may be disposed between the sample cavity 310 and the die 308. In an embodiment, gasket 312 may be a filter that facilitates filtration. The filter helps in retaining the suspension. It prevents the dispersion of suspension throughout the release media in USP apparatus type II. The sample cavity 310 may contain an optional plunger 316 (that places an upward pressure on the sample) to facilitate contact between the sample 314 and the media 330 contained in the dissolution vessel 306.

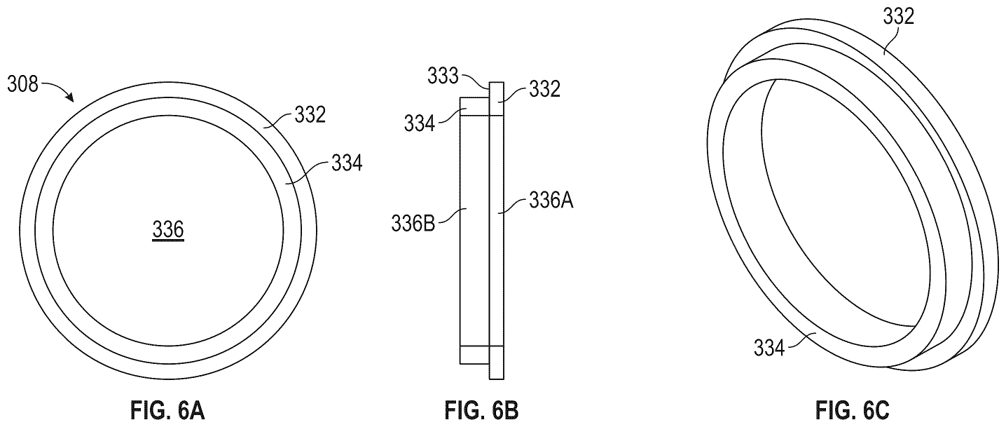

FIGS. 6(A), 6(B) and 6(C) are depictions of an exemplary die 308 for the adapter 305 of USP apparatus type II. The die is disposed on an opening of the cavity. In an embodiment, the die is disposed on a largest opening of the cavity in the container body. FIG. 6(A) is a top view, FIG. 6(B) is a side view and FIG. 6(C) is an isometric view of the die 308 that fits into the sample cavity 310 in the adapter 305 of USP apparatus type II. The die 308 comprises a lid 332 that contacts the upper portion of the sample cavity 310. The lid 332 comprises a horizontal portion 333 (when disposed on the sample cavity 310) that rests on the wall of the sample cavity 310. The lid 332 is in communication with a lip 334 that functions as a guide to direct the die 308 into the sample cavity 310. The lip 334 protrudes outwards from the lid 332 and is preferably perpendicular to the horizontal portion 333. The die 308 has an opening 336 at its center through which samples (e.g., an oral suspension) may be introduced into the sample cavity 310. The opening 336 extends through both the lip (336B) and the lid (336A).

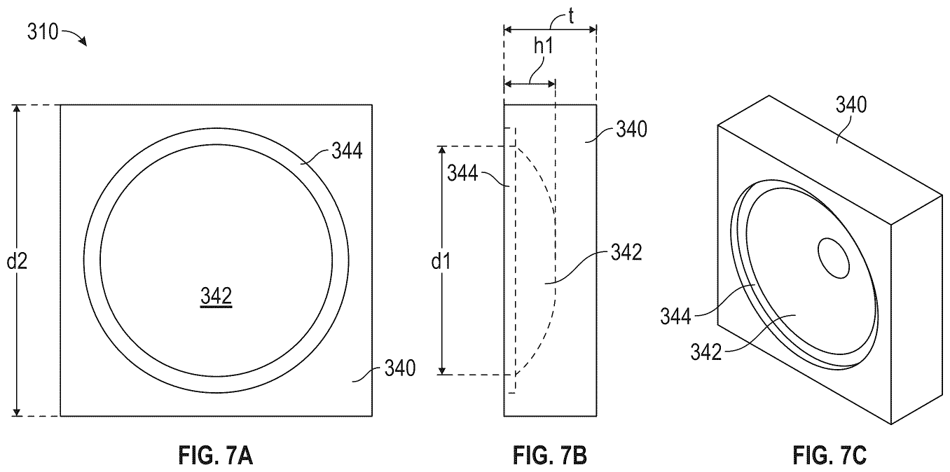

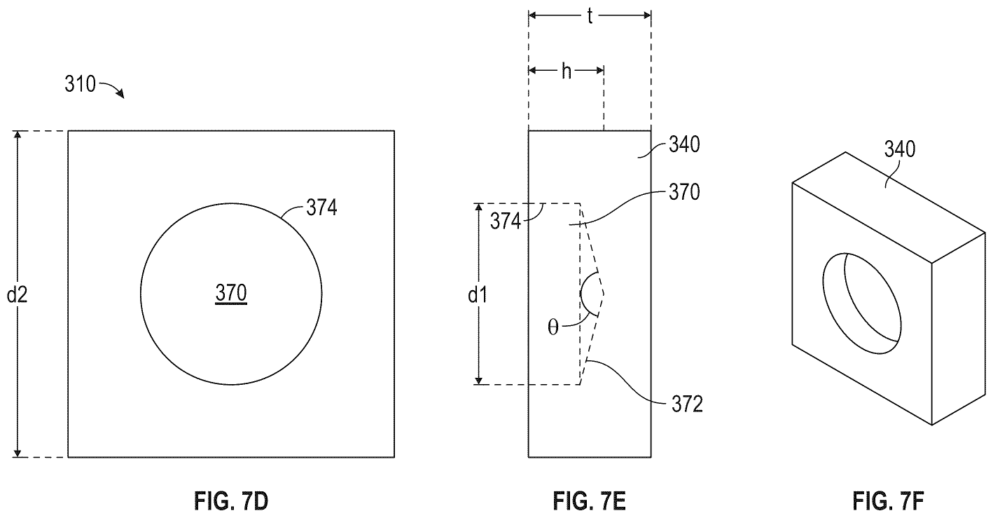

FIGS. 7(A), 7(B) and 7(C) are depictions of an exemplary sample cavity 310 into which the exemplary die 308 (of the FIGS. 6(A), 6(B) and 6(C)) fits. FIG. 7(A) is a top view, FIG. 7(B) is a side view and FIG. 7(C) is an isometric view of the sample cavity 310 in the adapter 305 of USP apparatus type II. The sample cavity 310 comprises a container body 340 having a downwardly protruding partial ellipsoid 342 in which the oral suspension can be disposed. The downwardly protruding partial ellipsoid 342 contains a ridge 344 at its upper portion into which the die 308 can slide. The ridge 344 has a vertical portion and a horizontal portion. The vertical portion serves as a guide for the die 308, while the horizontal portion serves as a resting place for the die 308.

As noted above, die 308 and the sample cavity 310 can contain a gasket or a filter 312 that facilitates filtration of fluids. The filter is typically a filter paper 312 which is disposed between the die 308 and the sample cavity 310 and regulates the amount of the oral sample that can be diluted and carried away by the media in the dissolution vessel. The filter paper typically is disposed across the opening 336 of the adapter 305.

FIGS. 7(D), 7(E) and 7(F) are depictions of an exemplary sample cavity 310 into which the exemplary die 308 (of the FIGS. 6(A), 6(B) and 6(C)) fits. FIGS. 7(D)-7(F) have a square outer periphery. FIG. 7(D) is a top view, FIG. 7(E) is a side view and FIG. 7(F) is an isometric view of the sample cavity 310 of the adapter 305 of USP apparatus type II. The sample cavity 310 comprises a container body 340 having a downwardly protruding cavity 370. The cavity 370 has a downwardly protruding conical section 372 in which the oral suspension can be disposed. The downwardly protruding conical section has an apex angle θ of about 130 to about 170 degrees. The downwardly protruding cavity 370 has a circular upper portion 374 into which the die 308 (of FIG. 6(A)) can slide. The vertical portion 374 serves as a guide for the die 308.

It is to be noted that the adapters described for use in the USP apparatus type IV (such as those described in FIGS. 3(A)-3(C) and 4(A)-4(C)) can be interchangeably used in the USP apparatus type II and those described for use in the USP apparatus type II (such as those described in the FIGS. 6(A)-6(C) and 7(A)-7(C)) can also be used interchangeably in the USP apparatus type IV.

As noted above, the containers and/or the lids described in the FIGS. 3(A)-3(C), 4(A)-4(C), 6(A)-6(C) and 7(A)-7(C) are all manufactured from polymers that will not react with or contaminate any of the fluids such as the media or the suspensions. Preferred polymers are fluoropolymers, polysiloxanes, polyolefins, polyesters, or a combination thereof.

The height “h1” of the downwardly protruding partial ellipsoid of FIGS. 7(A), 7(B) and 7(C) is about 3 to about 6 millimeters, preferably about 3.5 to about 5 millimeters. The diameter “d1” of the base of the downwardly protruding partial ellipsoid of FIGS. 7(A), 7(B) and 7(C) is 16 to 22 millimeters, preferably about 17 to about 20 millimeters. In an embodiment, the aspect ratio of the downwardly protruding partial ellipsoid (h1/d1) may be about 0.13 to about 0.35, preferably about 0.18 to about 0.30.

The container body 340 (with the downwardly protruding partial ellipsoid disposed therein) of FIGS. 7(A), 7(B) and 7(C) has a thickness “t” of about 6 to about 10 millimeters, preferably about 7 to about 9 millimeters. The container body may have a periphery that is square, circular, rectangular, ellipsoidal, triangular, polygonal, or a combination thereof. If the container body 340 has a square periphery, the side of the square “d2” may be about 20 to about 40 millimeters, preferably about 21 to about 25 millimeters. When container body 340 has a circular periphery, the outer diameter “d2” of the periphery 506 is about 20 to about 26 millimeters, preferably about 21 to about 25 millimeters.

The height “h1” of the downwardly protruding conical section 372 of FIGS. 7(D), 7(E) and 7(F) is about 3 to about 6 millimeters, preferably about 3.5 to about 5 millimeters. The diameter “d1” of the base of the downwardly protruding section of FIGS. 7(D), 7(E) and 7(F) is about 12 to about 22 millimeters, preferably about 14 to about 20 millimeters. In an embodiment, the aspect ratio of the downwardly protruding partial ellipsoid (h1/d1) may be about 0.13 to about 0.35, preferably about 0.18 to about 0.30.

The container body 340 (with the downwardly protruding partial ellipsoid disposed therein) of FIGS. 7(A), 7(B) and 7(C) has a thickness “t” of 8 to 13 millimeters, preferably 9 to 11 millimeters. The container body may have a periphery that is square, circular, rectangular, ellipsoidal, triangular, polygonal, or a combination thereof. If the container body 340 has a square periphery, the side of the square “d2” may be about 20 to about 40 millimeters, preferably about 21 to about 30 millimeters. When container body 340 has a circular periphery, the outer diameter “d2” of the periphery 506 is about 20 to about 26 millimeters, preferably about 21 to about 25 millimeters.

The adapters disclosed above are advantageous in that they are easy to fabricate and of low cost. The adapter improves the loading of long-acting injectable formulation in place and ensures good reproducibility in terms of sample loading and its shape. The in vitro dissolution studies using the adapters disclosed herein show good reproducibility and discriminatory ability. The duration of release testing may yield to successful Level A IVIVCs for long-acting injectable suspensions. Drug depots formed using this adapter are similar to what observed in the in vivo situation. These new adapters are capable of discriminating the LAI suspension formulations of the same particle but manufactured by different manufacturing approaches.

The adapters and the materials that are release-tested in these adapters are exemplified by the following non-limiting examples.

### Examples

### Materials Used

Materials such as medroxyprogesterone acetate (MPA, micronized, Unites States Pharmacopeia (USP) grade), methylparaben National Formulary grade (NF grade), Tween 80 (NF grade), propylparaben (NF grade) and polyethylene glycol (PEG) 3350 (NF-USP) were obtained from Spectrum Chemical Manufacturing Corp., New Brunswick, NJ, USA. PEG3350 was obtained from BASF in Ludwigshafen, Germany. Sodium chloride and sodium dodecyl sulfate (SDS) were purchased from Sigma-Aldrich in St. Louis, MO, USA. Poly-lactic-co-glycolic acid (PLGA) lactide:glycolide (L:G ratio 75/25 and 15/15) was procured from Evonik Corporation-Lactel® Absorbable Polymers (Birmingham, AL). Anhydrous N-methyl-2-pyrrolidone (NMP), sodium azide, and phosphate-buffered saline powder (PBS) were obtained from Sigma-Aldrich (St. Louis, MO). Triton X-100 was purchased from Fisher Scientific (Pittsburgh, PA). Perseris® and Depo Provera 150® were obtained from Amerisource Bergen (Norfolk St, Mansfield, MA). All the other chemicals used were of analytical grades.

### Methods Used

### Ultraperformance Liquid Chromatography UPLC Method for Medroxyprogesterone Acetate

An Alliance Waters (UPLC) system equipped with a quaternary solvent manager, a photodiode array detector and sample manager were utilized to analyze MPA. The data acquisition and analysis were performed using EMPOWER software and the chromatographic separation was achieved by employing a C18 Acquity ethylene bridged hybrid (BEH) column with dimensions of 50 mm×2.1 mm×1.7 mm. The samples were eluted using two different mobile phases. Mobile Phases A and B were prepared by mixing acetonitrile and water in a ratio of 90:10 v/v (volume per unit volume) and 10:90 v/v with 0.05% v/v trifluoroacetic acid. The optimized parameters for the effective separation of the drug are as follows:

| Chromatographic conditions | Optimized values |
|---|---|
| Injection volume (μL) | 1.0 |
| Flow rate (mL/min) | 0.3 |
| Column oven temperature (° C.) | 30 |
| Detection wavelength (nm) | 243 |

### Preparation of Sample Solution

To prepare samples for the calibration plot, 10 mg of MPA was added to a 10 mL volumetric flask. To this, approximately 7 ml of diluent (acetonitrile:water) in a 60:40 ratio was added and allowed to sonicate for 10 min in an ultrasonic bath. Finally, the remaining volume of diluent (3 milliliters) was added, and the solution was mixed well. The resulting solution was then used for the preparation of a calibration curve in the concentration range of 0.2 μg/ml to 100 μg/ml.

### Preparation and Characterization of Q1/Q2 Formulations of MPA Suspensions

To evaluate dissolution testing using the novel adapters, Q1Q2 equivalents to Depo Provera 150® were prepared by selecting excipient source as a critical material attribute and particle size of MPA as a critical quality attribute. The suspending media for the in-house Q1Q2 formulations was then prepared by dissolving all the required excipients in Milli-Q water. Media1 and Media2 contained PEG3350 obtained from Spectrum Chemical® and BASF Chemicals®, respectively. Media1 was used in the preparation of formulations “FA” and “FB,” while Media2 was employed for the formulation of FC. MPA obtained from Spectrum Chemicals® was used as such in “FA” and “FC.” However, for formulation “FB” of larger particle size, MPA was recrystallized using an antisolvent method as per the procedure outlined in the report published by Bao et al. (ref). All the formulations were prepared by stirring the dispersion at 600 RPM for 1 hour.

The in-house Q1Q2 equivalent formulations were characterized for particle size and size distribution. The particle size was evaluated using a MasterSizer (Malvern Instruments, UK). Approximately 30 μL of sample was dispersed in 1 mL of milli-Q water and the diluted suspension sample was injected into the particle sizing well until obscuration was achieved in the range of 2-20. For the estimation of particle size, the Dv10, Dv50, and Dv90 values were determined. The SPAN values were calculated to estimate the distribution of particle size.

### Dissolution Using Reported Methods.

### FDA Recommended Method.

Initially, the in vitro release studies were conducted using the dissolution method that had previously been documented in the FDA's dissolution database. This method recommended the use of USP apparatus type-II. Following this method in-house formulations “FA” and “FC” were introduced into 900 mL of dissolution media containing 0.35% w/v of SDS at 50±1 rpm and 37° C. Samples were withdrawn at specific time intervals and replaced with fresh dissolution media.

The above previously recommended in vitro method for Depo Provera 150®, was removed as of Sep. 23, 2023. The updated guidelines now propose that the applicant is responsible for developing an appropriate dissolution method to conduct drug release testing for this product. More information can be found at: https://www.accessdata.fda.gov/scripts/cder/dissolution/dsp_SearchResuIts.cfm

### Semisolid Adapter Using USP Apparatus Type-IV

A USP apparatus type-IV (CE 7 Smart with CP7 piston pump, Sotax AG, Switzerland) with flow-through cells (22.6 mm) and semisolid adapters of 1 mm depth was used to perform the in vitro release studies of Depo Provera 150® and the in-house Q1Q2 formulations. Semisolid adapters were placed in the flow-through cells and 50 μl of the suspensions were added to the flat surface of the semi-solid adapters. Two fiberglass filters, Whatman® GF/D (pore size 2.7 μm) and Whatman® GF/F (pore size 0.7 μm), were used within the filter head of the flow cells. The release studies were carried out using 500 ml of 1% w/v SDS at a flow rate of 8 ml/min. Each day, 1 ml samples were withdrawn and filtered using a 0.22 μm nylon filter before being introduced into the UPLC system. The release media was replenished with fresh media following sampling. All experiments were performed in triplicate.

### Dissolution Using Novel Adapters

Three distinct adapters were fabricated for release testing in both the USP-Type-II and USP-type-IV apparatus. Two different geometrical designs were employed for the USP apparatus type-IV (See FIGS. 3(A)-3(C) and 4(A)-4(C)), while one design was developed for the USP apparatus type-II (see FIGS. 6(A)-6(C) and 7(A)-7(C)).

### Design I & II—for USP-Apparatus Type-IV

The semi-solid adapter which is commonly used for the in vitro release testing of semisolid drug products such as creams, ointments and gels (Bao et al., 2018), is not ideal for in vitro release testing of long acting injectable (LAI) suspensions. The LAI suspensions have low viscosity compared to the semisolid drug products and therefore are not retained well on the flat surface of the semi-solid adapters. To overcome this issue, novel adapters were designed to hold the samples securely in place. Two separate designs, one with a shallow conical cavity (design I) and the other with an ellipsoid cavity (design II) were fabricated. The purpose of crafting separate designs was to accommodate different dosage volumes of samples for release testing. The adapter with conical geometry can accommodate up to 50 μl of suspension whereas the adapter with the ellipsoid cavity can accommodate up to 1 ml.

A USP apparatus type-IV (CE 7 equipment Smart with CP7 piston pump, Sotax AG, Switzerland) equipped with flow-through cells (22.6 mm) and the newly designed adapters featuring both conical and ellipsoid cavities were used for in vitro release studies on Depo Provera 150® and the in-house Q1Q2 equivalents. To set up the cells, the novel adapters were placed in the flow-through cell and the required amount of sample was loaded depending on the cavity size. For example, 50 μl for design I with the conical cavity and 1 ml for design II with the ellipsoid cavity. Within the filter head of the flow cells two different fiberglass filters, Whatman® GF/D (pore size 2.7 μm) and Whatman® GF/F (pore size 0.7 μm) were used.

The release studies were conducted using 500 ml of 1% w/v SDS at a flow rate of 8 ml/min. Each day, 1 ml samples were withdrawn, which were subsequently filtered using 0.22 μm nylon filters prior to being introduced into the UPLC system. Following each sampling, the release media was replaced with fresh media. For the release study performed using design II, the release media was replaced every 15 days to maintain the sink conditions. All experiments were carried out in triplicate.

### Design III—for USP Apparatus Type-II and Shaker Bath Method

### Adapter Design

The adapter design for USP apparatus type-II has a square shape with a conical cavity in the center. The square shape ensures the proper placement of the adapter in the USP apparatus type-II, while the conical cavity aids in retaining the sample. In the current study, the cavity dimensions were limited to accommodate sample dosage volumes up to 50 μl. However, this adapter design can be customized to create adapters with varying cavity sizes, ranging from 50 μl to 1 ml, for specific needs. To secure the sample within this cavity, a circular cap was employed, to which filter membranes with varying pore sizes can be attached. This adapter design is versatile and can be employed for drug release testing of suspensions, microspheres, and in situ forming implants.

### In Vitro Release Testing

For LAI suspensions, the design III adapter was utilized in both USP apparatus type-II and a shaker bath in vitro release testing method. In the shaker bath method, the adapters were placed in 500 ml Pyrex® round media storage bottles. The procedure for the release study is as follows: approximately 50 μl of sample was loaded into the conical cavity, and a 100 nm membrane filter was used to cover the sample compartment. The filter cap was slid onto the compartment to secure the sample. The dissolution studies were performed using 500 ml 1% w/v SDS at 37° C. at a paddle speed of 100 rpm, to ensure that sink conditions were maintained. Each day, 1 ml of sample was withdrawn, and subsequently filtered using a 0.22 μm nylon filter before being introduced into the UPLC system. Following each sampling, the release media was replaced with fresh media.

### Applicability of Design III for the In Vitro Release Testing of Other LAIs

The adapter design developed for USP apparatus type-II was evaluated for in vitro release testing of in situ forming implants.

### In Situ Forming Implants

### Preparation of In Situ Forming Implants

Two formulations of risperidone in situ forming implants were prepared using poly (lactic-co-glycolic acid) (PLGA) with different L:G ratios. The formulations were labelled R1 (L:G ratio 85/15) and R2 (L:G ratio 75/25). Briefly, PLGA and NMP were mixed in the weight ratio of 1:1.24 in a sterilized plastic syringe and stirred at room temperature until homogenous solutions were obtained. In another plastic syringe, 90 mg of risperidone was added. The contents of both syringes were then mixed by coupling the two syringes using a Nordson Medical female luer thread coupler. The contents of the two syringes were mixed by pushing the syringes back and forth until uniform suspensions of risperidone were obtained. The suspensions were then drawn into the (liquid) syringe. The two syringes were decoupled, and a needle for injection was affixed. The details of the formulations are given below in Table 1.

TABLE 1

| Formulation | PLGA | Solvent | Drug |
|---|---|---|---|
| R1 | 228 mg PLGA | 282 mg | 90 mg |
| | (MW: 26.4; L/G ratio: 85/15; | NMP | Risperidone |
| | Blockiness: 2.10; Acid endcap) | | |
| R2 | 228 mg PLGA | 282 mg | 90 mg |
| | (MW: 24.2; L/G ratio: 80/20; | NMP | Risperidone |
| | Blockiness: 2.15; Acid endcap) | | |

### In Vitro Release Method

Approximately 50 μl of the risperidone in situ forming implant suspensions were placed in the central conical cavity of the sample holder, and a 100 nm membrane filter was used to cover the sample compartment. The filter cap was slid onto the compartment to secure the sample. The assembled adapter was immersed into 500 mL of release media (pH 7.4 PBS, with 0.1% (w/v) sodium azide) prefilled in the USP apparatus type-II (paddle) (SOTAX AT, USA) vessels (37° C., 50 rpm) (Wang et al., 2023). Samples were withdrawn at predetermined intervals and replenished with fresh release media.

### Model Fitting of Drug Release Profiles

Different drug release models were investigated to understand the dissolution kinetics of the suspensions and in situ implants obtained using the novel adapter methods. The results are shown below in Table 3.

The UPLC method for MPA resulted in separation of MPA with good resolution and without any degradation. A calibration curve plotted using different concentrations showed good linearity with an r-squared value of 0.99. The linearity equation for the calibration curve is shown in Table 2.

TABLE 2

| Drug | Range of | Correlation | |
|---|---|---|---|
| substance | Linearity | coefficient | Linearity Equation |
| MPA | 0.2-100 μg/ml | 0.9994 | Y = 8115.1× − 4714.3 |

TABLE 3

| | | | Formulations | | | |
|---|---|---|---|---|---|---|
| | | | FA | FB | FC | RLD |
| LAIs | Dissolution method | Drug release model | Regression coefficient (r²) | | | |
| MPA | Apparatus: USP type-IV | Hixon Crowell cube root | 0.999 | 0.973 | 0.986 | 0.997 |
| suspensions | Adapter- Design I | law: F = 100 × | | | | |
| | Testing volume- 50 μl | [1 − (1 − k_{H}C × t)3] | | | | |
| | Apparatus: USP type-IV | F = fractional drug | 0.982 | | | |
| | Adapter- Design II | release | | | | |
| | Testing volume- 500 μl | K_{H}C = rate constant. | | | | |
| | Apparatus: USP type-IV | t = time | 0.994 | 0.987 | 0.993 | 0.990 |
| | Adapter- Design II | | | | | |
| | Testing volume- 1000 μl | | | | | |
| | Apparatus: USP type-II | | 0.989 | 0.917 | 0.995 | 0.986 |
| | Adapter- Design III | | | | | |
| | Testing volume- 50 μl | | | | | |
| | Apparatus: Sample and separate | Zero order: F = k₀*t K₀ = | 0.986 | 0.958 | 0.993 | 0.994 |
| | Adapter- Design III | rate constant t = time | | | | |
| | Testing volume- 50 μl | | | | | |

| | | | |
|---|---|---|---|
| Risperidone | Adapter for USP apparatus | Korsmeyer-Peppas with | Formulation with PLGA 75/25: |
| in-situ | type-II (Dose volume- 50 μl) | Tlag | r² = 0.9868, n = 0.76 |
| implants | | Mt/M∞ = K · (t − tlag) n | Formulation with PLGA 85/15: |
| | | Mt = drug release at | r² = 0.9372, n = 0.76 |
| | | time t | |
| | | M∞ = drug release at | |
| | | infinity, K = rate | |
| | | constant | |
| | | N = release exponent | |

A model-dependent approach was employed to analyze the drug release kinetics from the LAI suspensions and in situ implants. Several mathematical models describing different release mechanisms were evaluated to find the best fit for the in vitro dissolution data. These included the zero-order model (describing constant drug release over time), the first-order model (concentration-dependent release), the Higuchi model (drug release from the polymeric matrix by Fickian diffusion), and the Hixson-Crowell cube root law model. Among these, the Hixson-Crowell cube root law and zero-order drug release were identified as the most suitable model to describe the drug release behavior observed for the MPA suspensions with an R²>0.95 (refer Table3). The release data was generated using USP apparatus type-IV with adapter design I & II (See FIGS. 3A-3C for design I and FIGS. 4A-4C for design II) followed Hixson Crowel cube root kinetics. According to this model, drug particles undergo surface dissolution with a changing surface area over time (“Mathematical models of drug release,” 2015). In these adapter designs, the MPA suspensions are retained as a depot from which the drug particles slowly erode and dissolve over an extended period. This drug release behavior aligns well with the surface erosion mechanism assumed by the Hixson-Crowell model.

The dissolution data generated using USP apparatus type II with design III followed the Hixson-Crowell cube root law, while the data from the shaker bath method with adapter design III (See FIGS. 7A-7C for adapter design III) followed zero-order release kinetics. In adapter design III, the suspension sample is enclosed between the adapter and filter membrane, preventing contact of suspension with large amounts of release media. This results in the slow and gradual release of the drug from the suspension depot through the filter membrane. The observed differences in the release mechanisms are possibly due to the hydrodynamics of the USP apparatus type-II and the shaker bath method as discussed above.

For in-situ forming implants, the drug release process is inherently complex and may involve multiple mechanisms, including diffusion, polymer swelling/relaxation, and erosion. To elucidate the underlying release mechanisms, various mathematical models were evaluated to find the best fit for the in vitro dissolution data obtained using the developed adapters. As shown in Table 3 above, the dissolution data for both formulations with L:G ratios of 75:25 and 85:15 fits well to the Korsmeyer-Peppas model (R²>0.95). However, the value of release exponents (refer Table3) for formulations with L:G ratio 75:25 (n=0.76) and 85:15 (n=2.53) suggests that the formulation with a higher L:G ratio tends to deviate from Korsmeyer-Peppas model. The implant with higher L:G ratio is known to degrade more slowly compared to those with higher glycolide content. The slower degradation rate can lead to a more complex interplay between diffusion, polymer swelling, and erosion processes, which may not be adequately captured by the Korsmeyer-Peppas model.

### Particle Size Determination

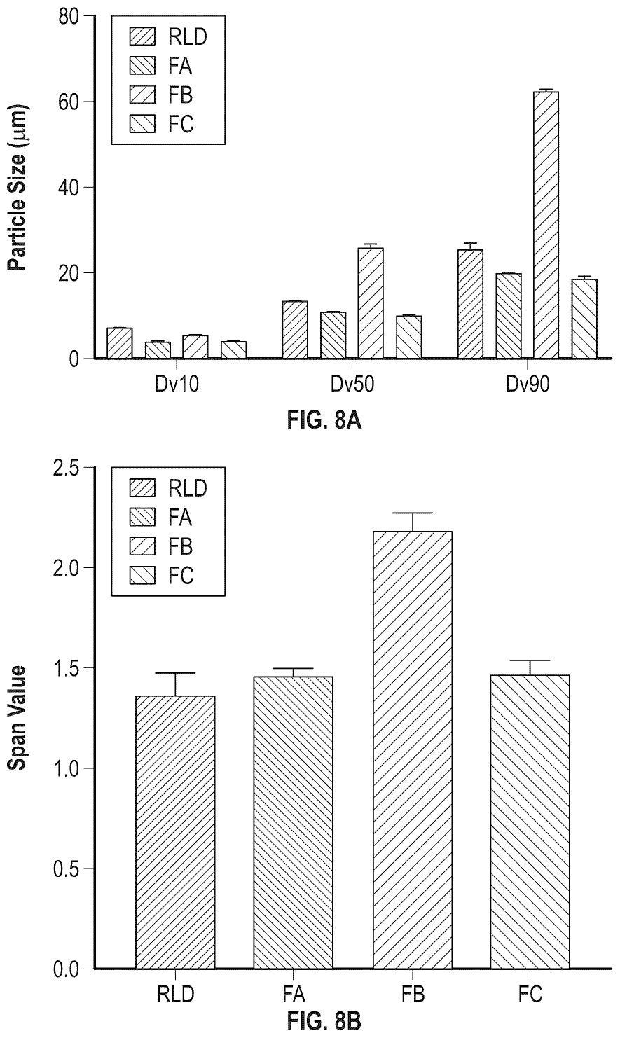

The particle size is a major critical quality attribute of LAI suspensions and can have a significant impact on the drug release. The rank order of the particle size for Depo Provera 150® and the in-house Q1Q2 equivalents is as follows: FB>RLD>FC˜FA. The results are shown in the FIGS. 8(A) and 8(B). FIG. 8 is a graph that shows (A) particle size; and (B) particle size distribution of Depo Provera 150® and the in-house Q1Q2 equivalents. Particle size analysis performed using MasterSizer (Malvern Instruments, UK).

### Dissolution Using Reported Methods

The FDA recommended dissolution testing method using USP apparatus type-II was first investigated to determine suitability and inform further method development.

### FDA Recommended Method

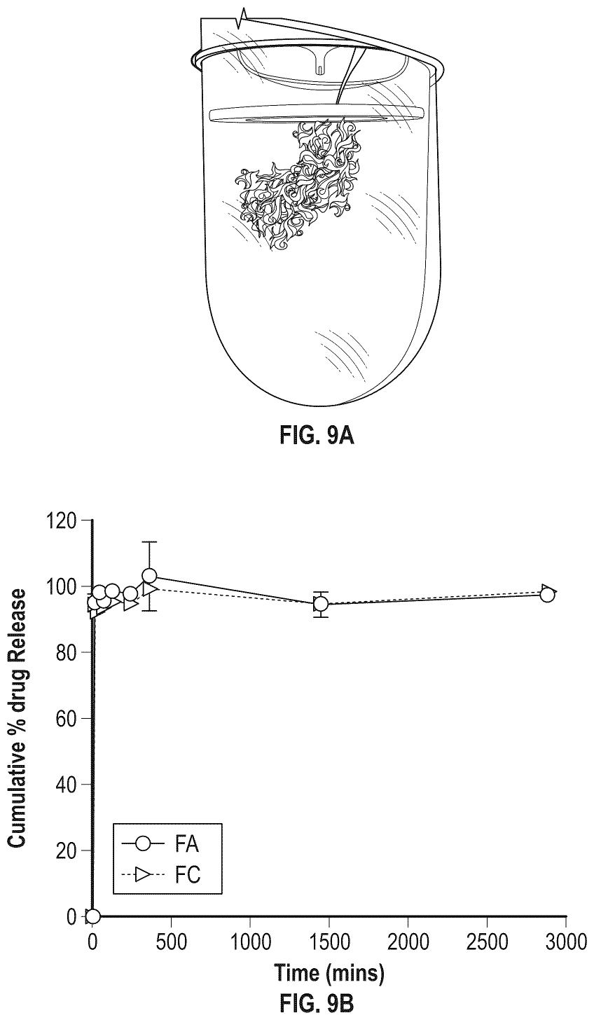

FIG. 9(A) shows the dispersion of suspension samples in USP apparatus type-II; FIG. 9(B) is a graph that depicts in vitro release profile of formulations “FA” and “FC” using USP apparatus type-II. The release studies were performed using 900 mL of 0.35% w/v SDS media at 50±1 rpm and 37° C. All data are presented as mean±SD, n=3. The drug release profiles for formulations “FA” and “FC” are represented in FIG. 9(B). The duration of drug release for both formulations was significantly shorter in duration compared to what has been reported for in vivo drug release (approximately 350-fold shorter in duration).

### Dissolution Using Semisolid Adapter for USP Apparatus Type IV

Semisolid adapters were utilized for the in vitro release testing of Depo Provera 150® and the in-house Q1Q2 equivalent formulations. The samples for the dissolution study are loaded on the flat surface of the adapter.

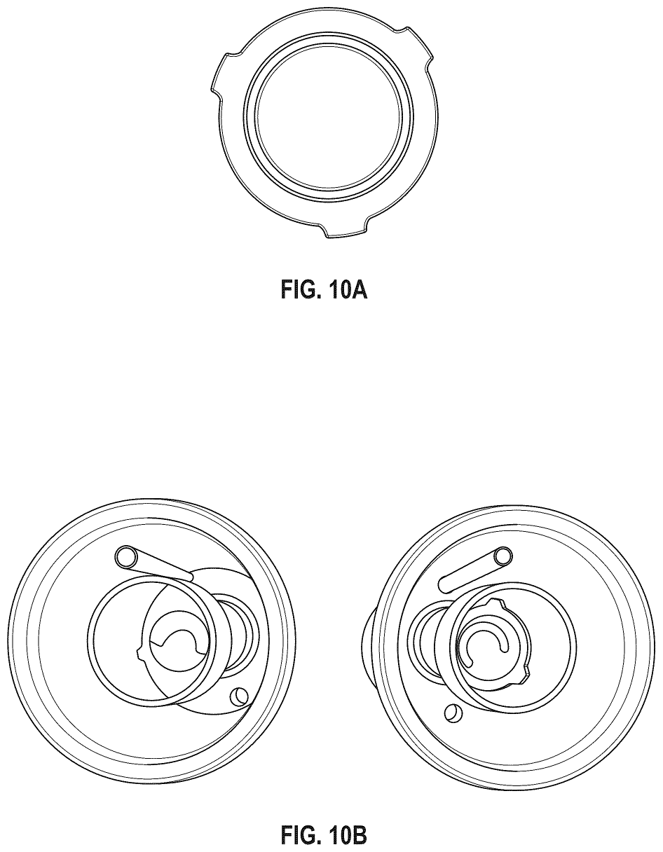

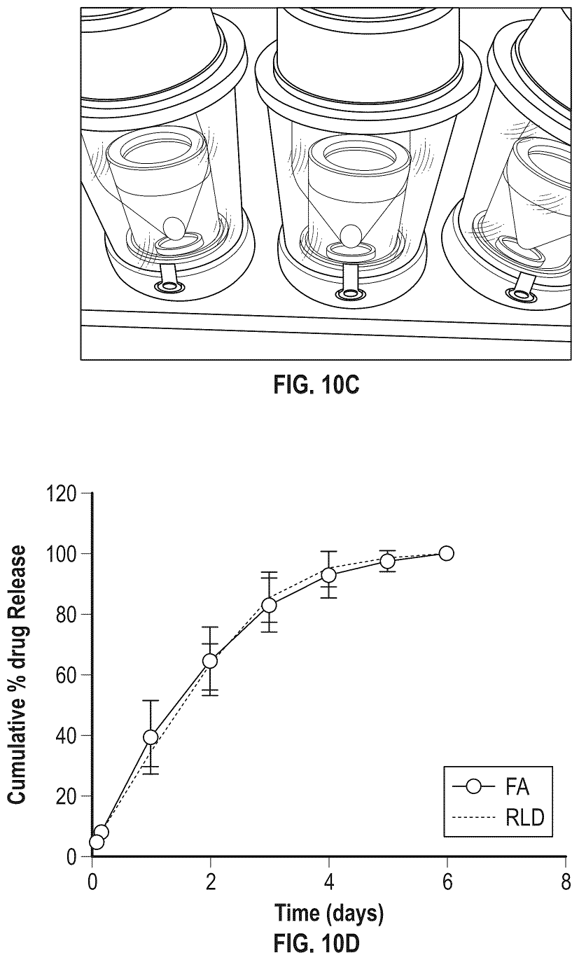

FIG. 10(A) is a photograph of a semisolid adapter; FIG. 10(B) depicts suspension spreading over the flat surface of semisolid adapter placed in flow through cells; FIG. 10(C) is a photograph of in vitro drug release of LAI suspension using semisolid adapter in a USP apparatus type-IV flow through cell; and FIG. 10(D) is a graph that shows in vitro release profile of formulation “FA” and the “RLD” using USP apparatus type-II. The release studies were performed using 500 mL of 1% w/v SDS media at a flow rate of 8 ml/min and a temperature of 37° C. All data are presented as mean±SD, n=3.

Any disturbance to the loaded sample, as shown in FIG. 10(B), results in smearing (spreading) of the LAI suspension over the flat surface of semi-solid adapter. This may lead to 1) a higher standard deviation between the tested samples, and 2) exposure of a large particle surface area, resulting in faster drug release, with complete drug release achieved within two weeks. The short duration of drug release is not desirable as a large time scaling factor would need to be applied for IVIVC development. In addition, this dissolution method could not adequately discriminate between formulation FA and the RLD, despite their differences in particle size (FIG. 10(D)).

### Dissolution Using Adapters Developed for USP Apparatus Type IV

Adapter with Shallow Conical-Shaped Cavity (See FIG. 3(A)-3(C))

The example was conducted using the adapter with the conical shaped cavity to securely retain the LAI suspension and perform release studies using minimal sample volume (up to 50 μl). Dissolution testing using smaller dose volumes becomes particularly advantageous when dealing with limited amounts of API, especially during the early stages of pharmaceutical product development. Therefore, this adapter could serve as a valuable asset in preliminary investigations of drug release from long-acting injectables.

Following preliminary investigation, the drug release for the entire dosage unit could be tested using the adapter with the ellipsoid shape cavity (design-II) that can hold larger sample volumes. However, it is important to note that the majority of LAI drug products contain extremely hydrophobic APIs, imposing solubility limitations on the amount of sample tested during in vitro drug release studies. When working with larger sample sizes, maintaining sink conditions becomes challenging.

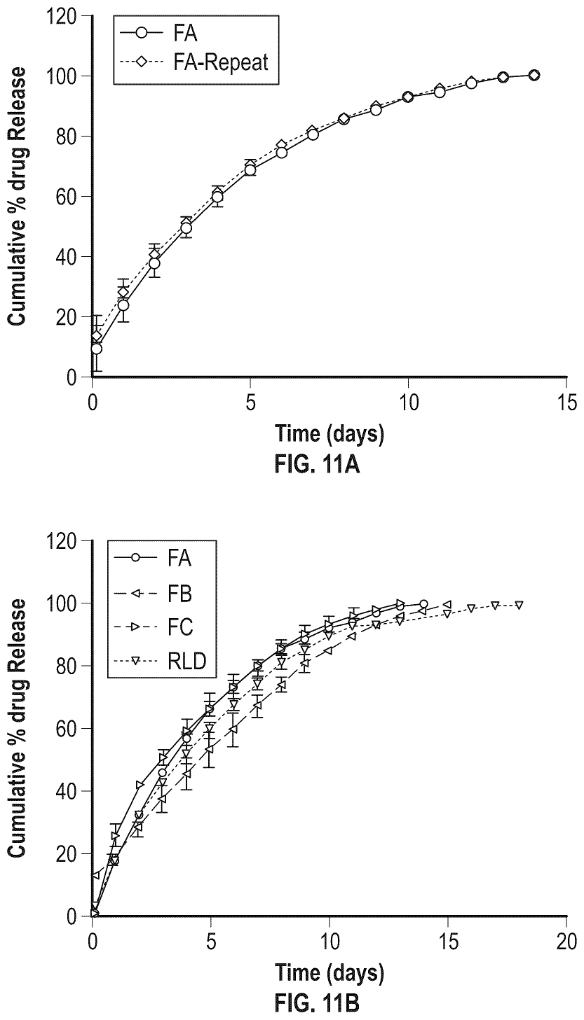

The adapter with a shallow conical cavity was advantageous when compared with the semi-solid adapter in terms of sample loading. This adapter can securely hold LAI suspension in place, and even the slight disturbance associated with assembling the flow-through cells does not cause spreading of the suspension. The in vitro release performed for Depo Provera 150® and its Q1/Q2 equivalents using a conical cavity showed consistent drug release profiles with minimal standard deviation (FIG. 11(B)). FIG. 11(A) is a graph that shows in vitro release profiles for formulation “FA” performed twice using the adapter in USP apparatus type-IV; and FIG. 11(B) reflects in vitro release profile of Depo Provera 150® and its Q1Q2 equivalents using the adapter in USP apparatus type-IV The release studies were performed using 500 mL of 1% w/v SDS media at a flow rate of 8 ml/min and temperature 37′C. (All data are presented as mean±SD, n=3).

The relative standard deviation for these drug release profiles was within ±5%. The reduced variation in drug release may be attributed to securely holding the sample within the cavity, preventing sample smearing, and ensuring a consistent surface area for dissolution. The drug release profiles were reproducible and showed good discrimination for the formulations of different particle sizes (FIGS. 11(A) and 11(B)).

The rank order of drug release for all formulations was in accordance with particle size: FA˜FC>RLD>FB. Formulations “FA” and “FC”, although having similar particle size, showed slight differences in the drug release, with FC being marginally faster than FA.

Adapter with Partial Ellipsoid Shaped Cavity (See FIGS. 4(A)-4(C))

From a regulatory standpoint, dissolution profiles generated using a partial volume (up to 50 μl using the conical cavity design of the FIGS. 3(A)-3(C) of the dosage may not be acceptable since dissolution data representative of entire dosage unit is usually required. To address both regulatory requirements and quality control perspectives, a separate adapter (See FIGS. 4(A)-4(C)) was developed for the release testing of the entire dosage unit.

In this design, the sample-holding partial ellipsoid cavity can accommodate volumes up to 1 ml, aligning with the typical dose volume range of 0.5 ml to 1 ml for most LAI drug products. This approach allows for a more comprehensive and representative assessment of drug release characteristics. However, the dosage volume of a few commercial long-acting suspension drug products can be higher than 1 ml. For example, the 2-month aripiprazole lauroxil injection has a dosage strength of 1064 mg with a dose volume of 3.9 ml (Hard et al., 2017). For the current partial ellipsoidal adapter only volumes (up to 1 ml) of high dose volume LAI products were accommodated. Therefore, a study was conducted to determine whether testing partial volumes could be representative of drug release from the entire dosage unit.

The results of release testing performed on formulation “FA” using different volumes: 0.05 ml (using the conical shaped adapter—design I); and 0.5 ml and 1 ml (using the ellipsoid shaped adapter-design II) are shown in FIG. 6(C). The data obtained from model fitting of the drug release profiles suggested that the dosage volumes did not have any impact on the drug release mechanisms. The profiles were discriminatory, and the release rates decreased with the increase in the dosage volume. For the larger dosage volumes, the initial concentration gradient is high; however, as the dissolution proceeds the concentration gradient decreases. The rate of saturation of the release media increases with increase in dose volume. As the media becomes saturated, the higher concentration of drug limits further dissolution of the drug present in the adapter, resulting in deceleration of the release rate.

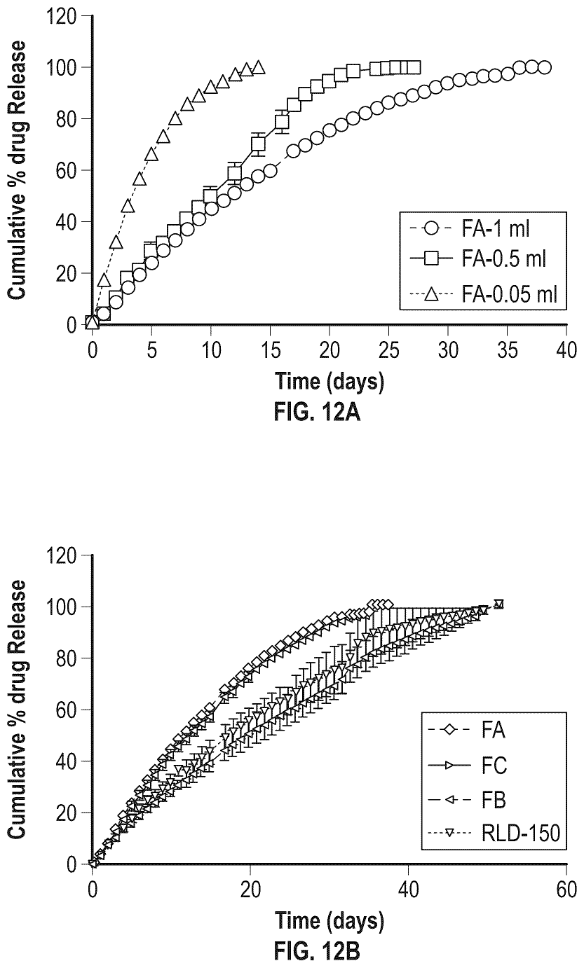

The drug release profiles for Depo Provera 150® and the in-house Q1/Q2 formulations obtained using this adapter (design-II) are illustrated in FIG. 12(A). FIG. 12(A) is a graph showing in vitro release profiles using different dose volumes of formulation “FA” in the partial ellipsoid shaped adapter; and FIG. 12(B) is a graph showing in vitro release profile of Depo Provera 150® and the in-house Q1Q2 equivalents using the ellipsoid shaped in USP apparatus type-IV The release studies were performed using 500 mL of 1% w/v SDS media at a flow rate of 8 ml/min and a temperature of 37° C. (All data are presented as mean±SD, n=3).

The release rates followed the rank order of their particle size, with the following sequence FA˜FC>RLD>FB. The drug release profiles for all the formulations using this adapter were similar to those obtained using the conical cavity and within acceptable standard deviation (RSD±10%). The slightly higher variation in the dissolution data using the partial ellipsoid may be due to the periodic replacement of release media to maintain sink conditions, potentially influencing the drug release rate. This adapter design exhibited better discriminatory ability compared to adapter design-I, probably due to testing of dosage unit.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An adapter for use in facilitating dissolution, the adapter comprising:
a container body; and
a cavity that is operative to contain a suspension disposed in the container body; where the cavity comprises a conical section that protrudes into the container body; or where the cavity comprises a partial ellipsoidal shape that protrudes into the container body.

2. The adapter of claim 1, where the conical section has an internal angle θ of about 130 to about 170 degrees.

3. The adapter of claim 2, where a height “h1” of the conical section is about 0.5 to about 3 millimeters and where a diameter “d1” of the base of the conical section is about 7 to about 12 millimeters.

4. The adapter of claim 2, where an aspect ratio (h1/d1) of the conical section is about 0.05 to about 0.5.

5. The adapter of claim 2, where the container body has a circular periphery and has a thickness “t” of about 5 to about 10 millimeters and an outer diameter periphery of about 15 to about 26 millimeters.

6. The adapter of claim 1, where the partial ellipsoidal shape has a height “h1” of about 3 to about 6 millimeters and a base diameter “d1” of about 16 to about 22 millimeters.

7. The adapter of claim 6, where the container body has a thickness “t” of about 6 to about 10 millimeters and has a circular periphery with an outer diameter “d2” of about 20 to about 26 millimeters.

8. The adapter of claim 1, where the partial ellipsoid shape has an aspect ratio (h1/d1) of about 0.13 to about 0.35.

9. The adapter of claim 1, further comprising a die that is disposed on an opening of the cavity.

10. The adapter of claim 1, where an outer periphery of the container body is a square, a rectangle, an ellipsoid, a circle, a triangle, a polygon, or a combination thereof.

11. The adapter of claim 9, where the container body and/or the die comprises polytetrafluoroethylene, polysiloxane, polyolefin, polyester, or a combination thereof.

12. An apparatus for facilitating dissolution, the apparatus comprising:
a reservoir comprising a dissolution media; where the dissolution media is operative to solvate a suspension that is therapeutically effective in a living being; and
a cell located downstream of the reservoir and in contact with it; where the cell is operative to contain an adapter that carries the suspension; where the adapter comprises:
a container body; and
a cavity disposed in the container body; where the cavity comprises a conical section that protrudes into the container body; or where the cavity comprises a partial ellipsoidal shape that protrudes into the container body.

13. The apparatus of claim 12, further comprising a pump disposed downstream of the reservoir and upstream of the cell and where the cell further comprises a one-way valve and a filter that lie upstream of the adapter.

14. The apparatus of claim 12, where the conical section has an internal angle θ of about 130 to about 170 degrees and an aspect ratio (h1/d1) of the conical section is about 0.05 to about 0.5.

15. The apparatus of claim 12, where the partial ellipsoidal shape has a height “h1” of about 3 to about 6 millimeters and a base diameter “d1” of about 16 to about 22 millimeters.

16. The apparatus of claim 12, where the partial ellipsoid shape has an aspect ratio (h1/d1) of about 0.13 to about 0.35.

17. An apparatus comprising:
a dissolution vessel that contains a rotating paddle shaft to which is affixed a paddle; where the dissolution vessel comprises a medium that is operative to solvate a suspension contained in an adapter; and
an adapter disposed in the medium in the dissolution vessel; wherein the adapter comprises a die disposed in a sample cavity; where the die comprises a lid that contacts the upper portion of the sample cavity; and where the sample cavity comprises a container body having a downwardly protruding partial ellipsoid shape in which the suspension is disposed; or where the sample cavity comprises a container body having a cavity that comprises a conical section that protrudes into the container body.

18. The apparatus of claim 17, where the partial ellipsoidal shape has a height “h1” of about 3 to about 6 millimeters and a base diameter “d1” of about 16 to about 22 millimeters.

19. The adapter of claim 17, where the container body has a thickness “t” of about 6 to about 10 millimeters and has a circular periphery with an outer diameter or side “d2” of about 20 to about 40 millimeters.

20. The adapter of claim 17, where the partial ellipsoid shape has an aspect ratio (h1/d1) of about 0.13 to about 0.35.
